(19) United States
(12) Patent Application Publication
(10) Pub. No.: US 2026/0106333 A1
(43) Pub. Date: Apr. 16, 2026

(54) CURRENT-CARRYING COMPONENT FOR SECONDARY BATTERY

(71) Applicant: NACHI-FUJIKOSHI CORP., Tokyo (JP)

(72) Inventors: Nobuyuki FUNAHIRA, Toyama-shi (JP); Maki SATAKE, Toyama-shi (JP); Atsuya HIRONO, Toyama-shi (JP); Kyohei WATANABE, Toyama-shi (JP); Taisei YUKI, Toyama-shi (JP); Naoki HONDA, Toyama-shi (JP)

(21) Appl. No.: 19/418,596

(22) Filed: Dec. 12, 2025

Related U.S. Application Data
(63) Continuation of application No. PCT/JP2024/017328, filed on May 10, 2024.

(30) Foreign Application Priority Data
Jun. 13, 2023 (JP) 2023-096673

(51) Int. Cl. H01M 50/503; H01M 50/522; H01M 50/526

(52) U.S. Cl. CPC H01M 50/503; H01M 50/522; H01M 50/526

(57) ABSTRACT

A current-carrying component for use in a secondary battery includes a plurality of metal foil members stacked one on top of another in the thickness direction of the metal foil members. Two or more through-holes are formed to extend through the metal foil members in the thickness direction of the plurality of metal foil members. The plurality of metal foil members are welded together by solid-phase welding to form a welded portion, which form a rim surrounding the through-hole. The inner peripheral surface of the welded portion constitutes the inner peripheral surface of the through-hole. A circular ring-shaped protrusion is provided at one end of the welded portion.

The present application is a continuation application of International Application No. PCT/JP2024/017328 having an international filing date of May 10, 2024, which claims priority to Japanese Patent Application No. 2023-096673, filed on Jun. 13, 2023, the entire content of each of which is incorporated herein by reference.

### BACKGROUND

### 1. Technical Field

The present invention relates to a current-carrying component for a secondary battery and more specifically a current-carrying component that electrically connects two or more rechargeable or secondary batteries for use in electric vehicles to establish electrical connection among the batteries.

### 2. Related Art

A current-carrying component, for example, a current-carrying component for use in connecting secondary batteries employed in electric vehicles or the like, is called a busbar which is typically formed with two or more plate members or foil members. The busbar is made of a highly conductive material such as aluminum alloy or copper alloy. Techniques for manufacturing a secondary battery and for manufacturing a conductive member for a secondary battery are disclosed, for example, in Japanese U.S. Pat. No. 6,971,990.

### SUMMARY

A current-carrying component for use in connecting secondary batteries according to an embodiment of the present invention includes a plurality of metal foil members stacked one on top of another in the thickness direction of the metal foil members. The current-carrying component has two or more through-holes formed to extend through the metal foil members in the stacking direction of the plurality of metal foil members. The plurality of stacked metal foil members includes at least one welded portion in which the metal foil members are welded together by means of solid-phase welding, the welded portion forms a rim surrounding the through-hole, and the inner peripheral surface of the welded portion constitutes the inner peripheral surface of the through-holes. A circular ring-shaped protrusion is provided at one end of the welded portion.

### BRIEF DESCRIPTION OF DRAWINGS

FIG. 1 is a schematic sectional view showing a current-carrying component 100 for use in a secondary battery according to a first embodiment of the present invention;

FIG. 2 is a schematic sectional view showing a current-carrying component 200 for use in a secondary battery according to a second embodiment of the present invention;

FIG. 3 is a schematic sectional view showing a current-carrying component 300 for use in a secondary battery according to a third embodiment of the present invention;

FIG. 4 shows a friction stir welding tool T used with the production of the current-carrying component for use in the secondary battery according to the embodiment of the present invention; and

FIG. 5 is an enlarged view of a portion A shown in FIG. 4.

### DETAILED DESCRIPTION

The following detailed descriptions are set forth for the purpose of explaining specific details of the embodiments of the present invention in order to facilitate the understanding of the present invention. It will be apparent, however, that one or more embodiments are not limited to the specific details and may be practiced with well-known structures and devices.

Conventionally, a bolt hole (through-hole) is formed through the current-carrying component in which metal foil members are stacked one on top of another, and the current-carrying component is fastened to the electrode of a secondary battery by a fastening bolt going through the bolt hole. When the current-carrying component is so fastened, in order to reduce the electrical resistance that causes the energy loss in power distribution, the contact between two adjacent metal foil members needs to be firmly established. That is, the current-carrying component needs to be rigid enough to withstand the fastening load exerted by the fastening bolt when the current-carrying component is fastened.

It is a conventional way to weld the metal foil members together by way of, for example, pressure bonding before the current-carrying component is fastened by the fastening bolt. However, the pressure boding can only give weak connection to two adjacent metal foil members, and because of the weak connection, the foil members warp. Thus, the current-carrying component bonded together by the pressure bonding cannot withstand the fastening load exerted by the fastening bolt and thus cannot exhibit the required low electrical resistance. Laser welding is another conventional way to weld the metal foil members together. The laser welding is not free from problem, however. If the metal foil members are misaligned from one another when the laser welding is performed, it is difficult to correctly perform the welding process, so that the metal foil members do not have aligned, even welded surfaces.

In order to address the above-described problems, the present invention contemplates to provide a current-carrying component for use in electrically connecting secondary batteries, in which the bolt hole (through-hole) formed through the metal foil members is formed aligned and even inner surfaces, while the bolt hole satisfies the required stiffness.

A current-carrying component for use in electrically connecting secondary batteries according to an embodiment of the present invention includes a plurality of metal foil members stacked one on top of another in the thickness direction of the metal foil members. Two or more through-holes are formed through the metal foil members of the current-carrying component so that the through-holes extend in the thickness direction of the plurality of metal foil members. The plurality of metal foil members are welded together by solid-phase welding to form a welded portion, which forms a rim surrounding the through-hole, and the inner surface of the welded portion constitutes the inner peripheral surface of the through-hole. A circular ring-shaped protrusion is formed at one end of the welded portion in the thickness direction.

The number of metal foil members can be equal to five or more. The thickness of each metal foil member may be equal to 0.21 mm or less. In this case, the metal foil members are made of any of aluminum, aluminum alloy, copper, and copper alloy.

The current-carrying component for use in electrically connecting secondary batteries according to the present embodiment is formed with the plurality of metal foil members. The two or more through-holes are formed through the metal foil members so that the through-holes extend in the thickness direction of the metal foil members. Specifically, the plurality of metal foil members are welded together by solid-phase welding to form the welded portion. The welded portion constitutes a rim surrounding the through-hole, and the inner peripheral surface of the welded portion constitutes the inner periphery surface of the through-hole. A ring-shaped step is formed at one end of the welded portion in the thickness direction of the metal foil members. Thus, contact between the metal foil members is firmly established. Moreover, the electrical conductivity of the current-carrying component should be high enough, while the current-carrying component should have enough stiffness. Further, a location where a fixing component such as a bolt is placed needs to be easily accessible when the bolt is fixed. Thus, the present embodiment ensures that the current-carrying component for use in electrically connecting secondary batteries can sufficiently rigid enough to withstand the fastening load exerted by the fastening bolt or the like when the current-carrying component for use in electrically connecting secondary batteries is fastened to the electrodes of the secondary batteries.

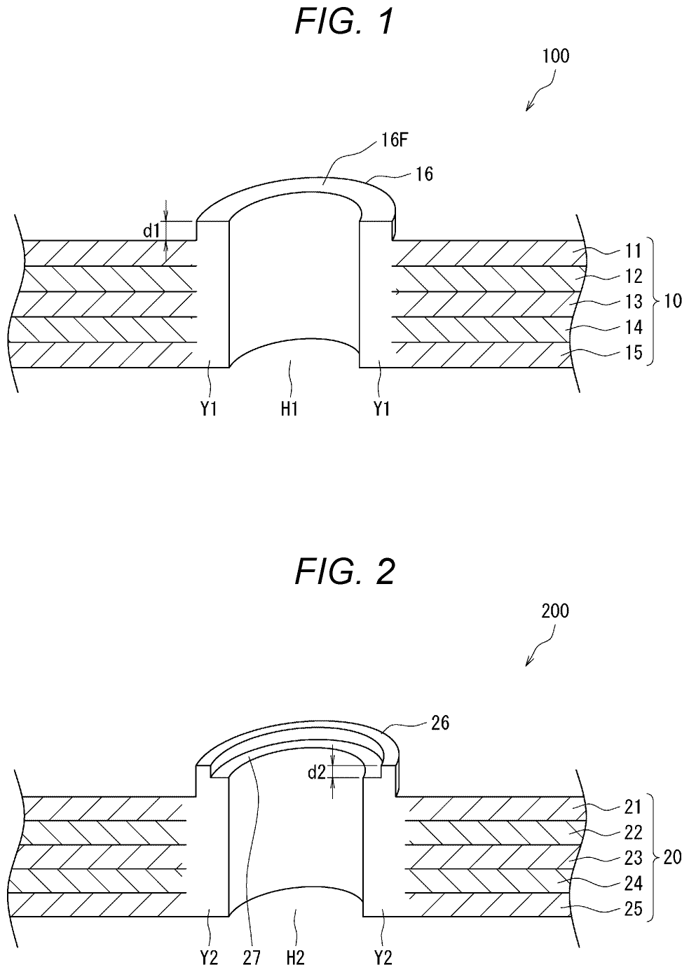

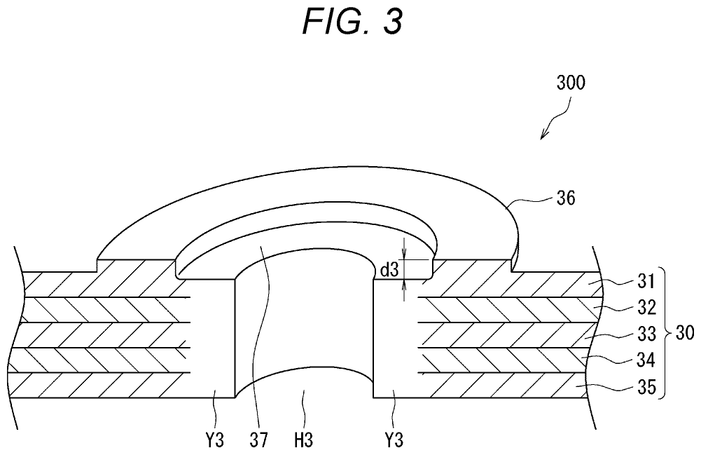

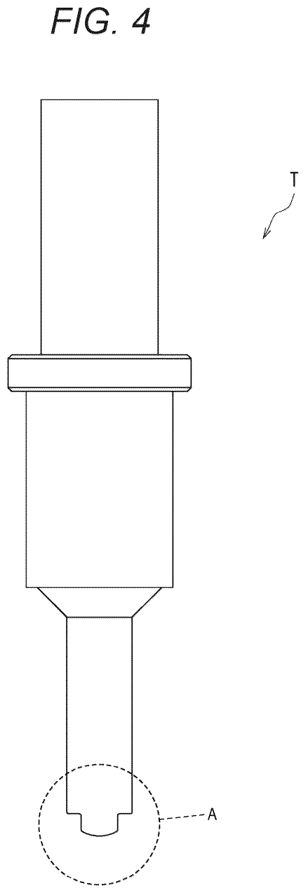

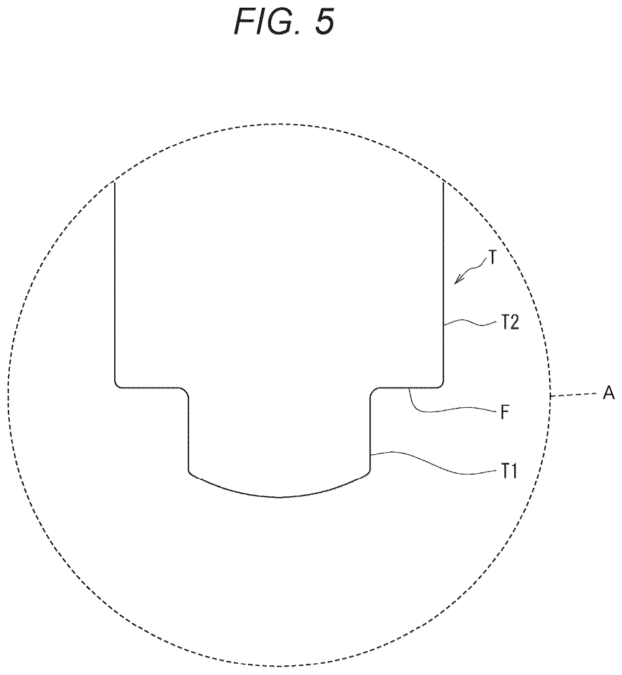

Current-carrying components for use in electrically connecting secondary batteries according to first, second, and third embodiments of the present invention will be described with reference to the drawings. FIG. 1 is a schematic sectional view showing a current-carrying component 100, formed with one through-hole H1, for use in electrically connecting secondary batteries according to the first embodiment of the present invention. FIG. 2 is a schematic sectional view showing a current-carrying component 200, formed with one through-hole H2, for use in electrically connecting secondary batteries according to the second embodiment of the present invention. FIG. 3 is a schematic sectional view a current-carrying component 300, formed with one through-hole H3, for use in electrically connecting secondary batteries according to the third embodiment of the present invention. FIG. 4 is a view showing a friction stir welding tool T used when the current-carrying component 200 shown in FIG. 2 and the current-carrying component 300 shown in FIG. 3 are manufactured. FIG. 5 is an enlarged view showing a tip end portion (shown by the circle A in FIG. 4) of the friction stir welding tool T.

As shown in FIG. 1, the current-carrying component 100 for use in electrically connecting secondary batteries according to the first embodiment is formed with a plurality of metal foil members 10 (11, 12, 13, 14, 15) stacked one on top of another in the thickness direction the metal foil members. As shown in FIG. 1, the current-carrying component 100 for use in electrically connecting secondary batteries has a through-hole H1. In the present embodiment, the five metal foil members 11, 12, 13, 14, 15 are welded together by solid-phase welding to (metallurgically and morphologically) weld the metal foil members one another to form a welded portion Y1, which forms a generally cylindrical rim surrounding the through-hole H1. The inner peripheral surface of the welded portion Y1 constitutes the inner peripheral surface of the through-hole H1.

As shown in FIG. 1, the current-carrying component 100 for use in electrically connecting secondary batteries according to the first embodiment is formed with a circular ring-shaped protrusion 16 provided at one end of the welded portion Y1 in the thickness direction of the metal foil members 10, i.e., on the metal foil member 11 stacked at the top of the current-carrying component. The circular ring-shaped protrusion 16 stands in the thickness direction of the metal foil members 10. On the metal foil member 11, which is located at the uppermost of the current-carrying component, the protrusion 16 stands as high as a height d1. An uppermost surface 16F of the protrusion 16 is formed as a horizontally flat surface. With this configuration, when the current-carrying component 100 for use in electrically connecting secondary batteries according to the first embodiment is fixed to the electrodes of secondary batteries with fixing devices such as a bolt or the like, the fixing devices, such as a bolt, a nut, and a washer can be stably placed on the upper part of protrusion 16. Note that the inner peripheral surface of the protrusion 16 extends continuously with the inner peripheral surface of the through-hole H1. That is, the inner peripheral surface of the protrusion 16 and the inner peripheral surface of the through-hole H1 together form a generally cylindrical inner peripheral surface of the through-hole H1.

Next, similarly to the first embodiment, the current-carrying component 200 for use in the secondary battery according to the second embodiment is formed with a plurality of metal foil members 20 (21, 22, 23, 24, 25) stacked one on top of another in the thickness direction of the metal foil members 20, as shown in FIG. 2. As shown in FIG. 2, the current-carrying component 200 for use in the secondary battery also has a through-hole H2 formed through the current-carrying component 200 in the thickness direction of the metal foil members 20. In the present embodiment, five metal foil members 21, 22, 23, 24, 25 are welded together also by solid-phase welding to (metallurgically and morphologically) weld the metal foil members 20 to form a welded portion Y2, which forms a generally cylindrical rim surrounding the through-hole H2. The inner peripheral surface of the welded portion Y2 constitutes the inner peripheral surface of the through-hole H2.

As shown in FIG. 2, the current-carrying component 200 for use in electrically connecting secondary batteries according to the second embodiment is formed with a circular ring-shaped protrusion 26 provided at one end of the welded portion Y2 in the thickness direction of the metal foil members 20, i.e., on the metal foil member 21 stacked at the top of the current-carrying component 200, similarly to the first embodiment. The circular ring-shaped protrusion 26 stands from the top surface of the metal foil member 21 stacked as the uppermost metal foil member. Further, as shown in FIG. 2, the circular ring-shaped protrusion 26 of the current-carrying component 200 for use in electrically connecting secondary batteries according to the second embodiment has a cylindrical wall, serving as a flange, standing as high as a height d2 that forms the top portion of the protrusion 25 on the radially outside of the circular ring-shaped protrusion 26. The cylindrical wall has a radial thickness smaller than the radial thickness of the protrusion 26 measured at the bottom of the protrusion 26, so that the cylindrical wall creates a circular step radially inside of the cylindrical wall. Note that the height d2 of the cylindrical wall is shorter than the entire height of the protrusion 26, and a lower part of the inner peripheral surface of the protrusion 26 located below the cylindrical wall is continuous with the inner peripheral surface of the through-hole H2. That is, the lower part of the inner peripheral surface of the protrusion 26 below the cylindrical wall and the inner peripheral surface of the through-hole H2 together form a generally cylindrical inner peripheral surface.

The circular step created by the cylindrical wall radially inside of the cylindrical wall forms a horizontally flat circular surface 27. The horizontally flat circular surface 27 is formed higher than the top surface of the metal foil member 20. That is, the height d2 of the cylindrical wall of the circular ring-shaped protrusion 26 is smaller than that of the entire height of the circular ring-shaped protrusion 26. The horizontally flat circular surface 27 provides a seat on which the fixing devices, such as a bolt, a nut, and a washer, are stably placed when the current-carrying component 200 for use in the secondary battery according to the second embodiment is fixed to the electrodes of secondary batteries with the fixing devices. The cylindrical wall serving as a flange is formed radially outside (on the radially outer side of) the flat surface 27. As a result, a fixing component such as a bolt, a nut, or a washer can also be easily positioned.

Note that the horizontally flat circular surface 27 of the current-carrying component 200 for use in electrically connecting the secondary battery as shown in FIG. 2 can be formed using the tip end portion of the friction stir welding tool T shown in FIG. 4. As shown in FIG. 5, the tip end portion of the friction stir welding tool T has a flat portion F having a large diameter T2 and a small diameter portion T1 extending from the center of the flat portion F. The small diameter T1 corresponds to the inner diameter of the protrusion 16 measured at the bottom of the protrusion 16. The large diameter T2 corresponds to the inner diameter of the cylindrical wall forming the top portion of the protrusion 16.

Similarly to the first and second embodiments, the current-carrying component 300 for use in electrically connecting secondary batteries according to the third embodiment is formed of a plurality of metal foil members 30 (31, 32, 33, 34, 35) stacked one on top of another in the thickness direction of the metal foil members 30, as shown in FIG. 3. As shown in FIG. 3, the current-carrying component 300 for use in electrically connecting secondary batteries also has the through-hole H3 formed vertically through the metal foil members 30. In the present embodiment, five metal foil members 31, 32, 33, 34, 35 are welded together also by solid-phase welding to (metallurgically and morphologically) weld the metal foil members together to form a welded portion Y3, which forms a generally cylindrical rim surrounding the through-hole H3. The inner peripheral surface of the welded portion Y3 constitutes the inner peripheral surface of the through-hole H3.

As shown in FIG. 3, the current-carrying component 300 for use in electrically connecting secondary batteries according to the third embodiment has a circular ring-shaped protrusion 36 provided at one end of the welded portion Y3 in the thickness direction of the metal fil members 30, i.e., on the metal foil member 31 stacked at the uppermost of the current-carrying component 300, similarly to the above-described first and second embodiments. The circular ring-shaped protrusion 36 stands from the upper surface of the metal foil member 31 stacked as the outermost metal foil member. The circular ring-shaped protrusion 36, as shown in FIG. 3, has a horizontally flat circular top surface. Fixing devices such as a bolt, a nut, and a washer can be stably placed on the horizontally flat circular surface 37. Similarly to the second embodiment, a cylindrical wall serving as a flange is formed as high as a height d3 as a top portion of the protrusion in the current-carrying component 300 for use in the secondary battery according to the third embodiment, as shown in FIG. 3.

The inner diameter of the protrusion 36 is larger than the inner diameter of the through-hole H3, so that a horizontally flat circular surface 37 is formed at the bottom of the protrusion 36 on the radially inner side of the protrusion 36. That is, the fixing devises such as a bolt, a nut, and a washer can be stably placed on the horizontally flat circular surface 37 when the current-carrying component 300 for use in the secondary battery according to the third embodiment is fixed to the electrodes of secondary battery As a result, the fixing devices such as a bolt, a nut, and a washer can also be easily positioned on the flat circular surface 37. In the third embodiment, the horizontally flat circular surface 37 is formed lower than the top surface of the metal foil member 30. That is, the height d3 of the inner peripheral surface of the circular ring-shaped protrusion 36 is greater than that of the height of the outer peripheral surface of the circular ring-shaped protrusion 36 measured from the top surface of the metal foil member 21.

Note that the horizontally flat circular surface 37 of the current-carrying component 300 for use in the secondary battery as shown in FIG. 3 can be formed using the friction stir welding tool T shown in FIG. 4. The diameter T2 of the flat portion F corresponds to the inner diameter of the cylindrical wall. The diameter of the small-diameter portion T1 corresponds to the inner diameter of the through-hole H3 as shown in FIG. 5.

Note that where the metal foil member is made of aluminum or aluminum alloy, the thickness of each metal foil member can be equal to 0.2 mm or less (JIS H4160, H4170). Where the metal foil member is made of copper or copper alloy, the thickness of each metal foil member can be equal to 0.21 mm or less (JIS C6515).

The foregoing detailed description has been presented for the purposes of illustration and description of the embodiments of the present invention. Modifications and variations of the above-described embodiments are possible in light of the above teaching. It is not intended to be exhaustive or to limit the subject matter of the present invention to the precise forms disclosed and explained above. Although the subject matter of the present invention has been described with language specific to structural features and/or methodological acts, it is to be understood that the subject matter of the present invention is defined in the appended claims and is not necessarily limited to the specific features or acts described above. Rather, the specific features and acts described above are disclosed as exemplary forms that practices the present invention.

What is claimed is:

1. A current-carrying component for use in a secondary battery, comprising:
a plurality of metal foil members stacked one on top of another in a thickness direction the metal foil members,
wherein the plurality of stacked metal foil members have two or more through-holes formed to extend through the plurality of stacked metal foil members in the thickness direction of the plurality of metal foil members,
the plurality of metal foil members are welded together by solid-phase welding to form welded portions, wherein each of the welded portion forms a rim surrounding the through-hole, and
a circular ring-shaped protrusion is provided at one end of each of the welded portion.

2. The current-carrying component for the secondary battery according to claim 1, wherein the circular ring-shaped protrusion has an inner surface with an annular flat step design for a fixing device to sit on.

3. The current-carrying component for the secondary battery according to claim 1, wherein
each of the metal foil members includes five or more metal foil members stacked one on top of another in the thickness direction of the metal foil members, and
a thickness per metal foil member is equal to 0.21 mm or less.

4. The current-carrying component for the secondary battery according to claim 2, wherein
the metal foil members include five or more metal foil members stacked on each other in the thickness direction, and
a thickness per metal foil member is 0.21 mm or less.

5. The current-carrying component for the secondary battery according to claim 1, wherein each of the metal foil members is made of any of aluminum, aluminum alloy, copper, and copper alloy.

6. The current-carrying component for the secondary battery according to claim 2, wherein each metal foil member is a metal foil member made of any of aluminum, aluminum alloy, copper, and copper alloy.

7. The current-carrying component for the secondary battery according to claim 3, wherein each metal foil member is a metal foil member made of any of aluminum, aluminum alloy, copper, and copper alloy.

8. The current-carrying component for the secondary battery according to claim 4, wherein each metal foil member is a metal foil member made of any of aluminum, aluminum alloy, copper, and copper alloy.
